(19) United States
(12) Patent Application Publication
(10) Pub. No.: US 2024/0078912 A1
(43) Pub. Date: Mar. 7, 2024

(54) SYSTEMS AND METHODS FOR VEHICLE TRANSIT OPTIMIZATION

(71) Applicant: Honeywell International Inc., Charlotte, NC (US)

(72) Inventors: Kalimulla KHAN, Bangalore, NJ (US); Manish GOSWAMI, Mumbai (IN); Raghu SHAMASUNDAR, Bengaluru (IN)

(21) Appl. No.: 18/056,882

(22) Filed: Nov. 18, 2022

(30) Foreign Application Priority Data
Sep. 2, 2022 (IN) 202211050170

(51) Int. Cl. G08G 5/00; G07C 5/00

(52) U.S. Cl. CPC G08G 5/0004; G07C 5/008

(57) ABSTRACT

A method for optimizing a transit of a vehicle with an estimated time of arrival to a destination includes, during the transit of the vehicle, performing, by one or more processors located off-board the vehicle, operations including: receiving data impacting the estimated time of arrival of the vehicle to the destination; optimizing, based on the received data, a parameter for an operation of the vehicle to maintain the estimated time of arrival to the destination within a threshold time, wherein the optimizing the parameter includes changing one or more of a speed or a route of the vehicle; and sending the optimized parameter to the vehicle.

### CROSS-REFERENCE TO RELATED APPLICATION

This application claims the benefit of priority under 35 U.S.C. § 119 from Indian Patent Application No. 202211050170, filed on Sep. 2, 2022, the entirety of which is incorporated herein by reference.

### TECHNICAL FIELD

Various embodiments of the present disclosure relate generally to optimizing a transit of a vehicle with an estimated time of arrival to a destination.

### BACKGROUND

Flight planning in revenue operations is typically done several hours before a flight using available forecast for weather, traffic, passengers, and payload estimates. Flight planning tools compute an Operational Flight Plan (OFP) considering several factors such as forecast and historical weather and traffic along the route, historically approved flight levels and speeds, airport and airspace usage fees, and optimization strategies for time and fuel, for example. However, prior to the flight departure or during the flight, dynamic factors such as weather, traffic, Air Traffic Control (ATC) restrictions, passenger load or payload deviations, departure delays, and airport traffic congestion can occur, which result in the need for in-flight modifications for safety and operational efficiency of the flight.

The present disclosure is directed to overcoming one or more of these above-referenced challenges.

### SUMMARY OF THE DISCLOSURE

In some aspects, the techniques described herein relate to a method for optimizing a transit of a vehicle with an estimated time of arrival to a destination, the method including: during the transit of the vehicle, performing, by one or more processors located off-board the vehicle, operations including: receiving data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle; optimizing, based on the received data, a parameter for an operation of the vehicle to maintain the estimated time of arrival to the destination within a threshold time, wherein the optimizing the parameter includes changing one or more of a speed or a route of the vehicle; and sending the optimized parameter to the vehicle.

In some aspects, the techniques described herein relate to a method, wherein the vehicular traffic includes information associated with another vehicle using a passenger disembarking point designated for the vehicle.

In some aspects, the techniques described herein relate to a method, wherein the received data is a difference between an estimated and actual zero fuel weight of the vehicle.

In some aspects, the techniques described herein relate to a method, wherein the optimizing is further based on one or more of a transit plan for the vehicle, current weather, or optimization initiatives recommended for the transit.

In some aspects, the techniques described herein relate to a method, wherein the optimizing includes re-planning a speed of the vehicle without changing a route of the vehicle.

In some aspects, the techniques described herein relate to a method, further including: monitoring each of an environmental condition, vehicular traffic, a transit restriction, a deviation in a payload of the vehicle, a delay in a departure of the vehicle, a difference between an estimated and actual zero fuel weight of the vehicle, a request from a controller for the destination, and a request from an operator of the vehicle in a holistic manner.

In some aspects, the techniques described herein relate to a method, wherein the vehicle is an aircraft.

In some aspects, the techniques described herein relate to a method, wherein the optimizing is further based on one or more of speed, altitude, fuel, or performance data of the aircraft.

In some aspects, the techniques described herein relate to a method, wherein the optimizing includes maintaining a time of arrival at a given waypoint en route to the destination by managing a speed profile of the aircraft subject to regulatory flight plan restrictions.

In some aspects, the techniques described herein relate to a method, wherein the optimizing the parameter further includes changing one of a speed of the vehicle or a route of the vehicle, and evaluating whether the vehicle will maintain the estimated time of arrival to the destination within a threshold time based on the changed one of a speed of the vehicle or a route of the vehicle.

In some aspects, the techniques described herein relate to a method, wherein the optimizing the parameter further includes changing the other of a speed of the vehicle or a route of the vehicle when the evaluating indicates the vehicle will not maintain the estimated time of arrival to the destination within the threshold time, and evaluating, for a second time, whether the vehicle will maintain the estimated time of arrival to the destination within the threshold time based on the changed other of a speed of the vehicle or a route of the vehicle.

In some aspects, the techniques described herein relate to a method, wherein the optimizing the parameter further includes changing both of a speed of the vehicle and a route of the vehicle when the evaluating, for the second time, indicates the vehicle will not maintain the estimated time of arrival to the destination within the threshold time, and evaluating, for a third time, whether the vehicle will maintain the estimated time of arrival to the destination within the threshold time based on the changed both of a speed of the vehicle and a route of the vehicle.

In some aspects, the techniques described herein relate to a method, wherein the optimizing evaluates and adjusts optimization initiatives against an overall impact to transit of the vehicle.

In some aspects, the techniques described herein relate to a method, wherein the receiving the data is based on one or more of a change in the data, a request from an operator of the vehicle, or a periodic update.

In some aspects, the techniques described herein relate to an off-board system to communicate with a vehicle management system onboard a vehicle and optimize a transit of the vehicle with an estimated time of arrival to a destination during the transit of the vehicle, the off-board system including: an operational transit plan database to store an operational transit plan for the vehicle; a scenario planner to: receive data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle, and optimize, based on the received data, a parameter for an operation of the vehicle to maintain the estimated time of arrival to the destination within a threshold time; and a route generator to insert the received data into an evaluation copy of the stored operational transit plan, evaluate a change to the estimated time of arrival based on the inserted data and the optimized parameter, and generate an impact summary based on the evaluated change, wherein the scenario planner is further configured to send the optimized parameter to the vehicle management system based on the impact summary.

In some aspects, the techniques described herein relate to a system, further including: an optimization initiative database to store an optimization initiative for the vehicle, wherein the scenario planner is further configured to optimize the parameter based on the received data and the optimization initiative.

In some aspects, the techniques described herein relate to a system, wherein the optimization initiative includes a restriction to one or more of a speed or route of the vehicle.

In some aspects, the techniques described herein relate to a system, wherein the scenario planner is further configured to choose another parameter for optimization when the impact summary indicates the change to the estimated time of arrival is outside a threshold value.

In some aspects, the techniques described herein relate to a system, wherein the vehicle is an aircraft and the parameter is one or more of a flight level, a direct route, or a route deviation.

In some aspects, the techniques described herein relate to a non-transitory computer-readable medium storing instructions, that when executed during a transit of a vehicle by at least one processor located off-board the vehicle, perform a method for optimizing the transit of the vehicle with an estimated time of arrival to a destination, the method including: receiving data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle; optimizing, based on the received data, a parameter for an operation of the vehicle to maintain the estimated time of arrival to the destination within a threshold time, wherein the optimizing the parameter includes changing one or more of a speed or a route of the vehicle; and sending the optimized parameter to the vehicle.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for an off-board system to communicate with a vehicle management system onboard a vehicle and optimize a transit of the vehicle with an estimated time of arrival to a destination during the transit of the vehicle, according to one or more embodiments.

FIG. 2 depicts an exemplary system infrastructure for an off-board system to communicate with a flight management system onboard an aircraft and optimize a flight of the aircraft with an estimated time of arrival to a destination during the flight of the aircraft, according to one or more embodiments.

FIG. 3 depicts an implementation of a computer system that may execute techniques presented herein, according to one or more embodiments.

FIGS. 4-6 depict a flowchart of a method for optimizing a transit of a vehicle with an estimated time of arrival to a destination, according to one or more embodiments.

### DETAILED DESCRIPTION OF EMBODIMENTS

Various embodiments of the present disclosure relate generally to optimizing a transit of a vehicle with an estimated time of arrival to a destination.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Dispatch or onboard flight planning and optimization products identify in-flight deviations such as direct routes, tailwind jet-stream-based flight levels, weather and turbulence avoiding routes, for example, that improve the safety of the flight or optimize the flight operations by reduction of the fuel burn or the flight time. However, these deviations are limited to the current phase of a flight, and do not necessarily consider the down-path impact to the flight mission, especially to the impact to the time of arrival. An early or late arrival can have a cascading effect on airline and ATC operations. Early arrivals due to en route flight optimization could result in arrival control holding an aircraft until a vacant slot is available to accommodate the landing. Also, at busy hubs, an early arrival could lead to an aircraft being stationed temporarily at the tarmac due to a lack of gate availability, which may cause disruption in ground handling and inconvenience to the passengers. Late arrivals due to departure or en route weather or traffic deviations can lead to missed landing slots, which causes further holds at the destination. Besides passengers missing connecting flights, an early or late arrival can also affect following arrivals and departures, due to disruption in ground handling and gate occupancy at busy airports.

There is a need to manage the in-flight deviations in an integrated manner to ensure minimum disruptions to the mission parameters. The key to avoid disruptions in flight operations due to in-flight deviations is to maintain the time of arrival for every flight. The time of arrival may be set during pre-flight operations or at takeoff, and may be a touchdown time at a destination runway, for example. The time of arrival may also include time for an aircraft to travel from touchdown to an allocated gate for the aircraft. While safety related flight deviations are unavoidable, in-flight optimization-related disruptions to the mission are counterproductive and should be avoided.

The disclosed systems and methods may avoid disruptions in flight operations due to in-flight deviations and maintain the time of arrival for every flight, thereby avoiding a cascading effect of early or late arrivals on airline and ATC operations, disruption in ground handling, and inconvenience to passengers.

The disclosure describes a comprehensive mechanism to manage in-flight deviations by integrating features and functions of a flight management system into flight safety and efficiency advisories. The disclosed system may be hosted in the airline operational control and may perform the following operations in real-time during a flight: (1) continuously monitor the mission and operating conditions against dynamic factors such as weather and traffic, for example, (2) prioritize the operating criteria (such as real time of arrival, speed, or cost index, for example) based on a prevailing mission requirement, and (3) re-plan and advise the mission as per operator configuration.

The operating criteria may be prioritized based on weighing multiple factors, such as time of arrival, fuel cost, and safety considerations (such as a standard operating procedure), for example, against overall operational benefits for a particular flight from a start to an end of the flight. Here, the multiple factors may each include an assigned weight value, for example. The operating criteria may depend on a fleet type, for example. For example, for a business jet, arrival time may be prioritized, and for air transport, fuel may be prioritized. The disclosure describes a comprehensive mechanism to determine the overall efficiency by considering the overall mission. As an example, changing a flight path to a higher cruise altitude may gain fuel savings, but may result in an early arrival to a gate, which may cause a delay for passengers. However, the change in cruise altitude may be accompanied by a change in speed to accommodate the arrival time within a threshold arrival time to avoid delays at a destination airport.

For every flight in progress in airline operations, the disclosed system continuously monitors any mission deviations due to dynamic factors that necessitate re-planning of the mission. These factors may include, but are not limited to, a difference between estimated and actual zero fuel weight, a takeoff delay, destination airport request for early or delayed arrival, ATC permission for airline-initiated en route shortcut, ATC permission for airline-initiated level change, ATC requested en route delay, destination holding, and a change in weather, for example.

The disclosed system has access to operational flight plans for every flight, the current weather data, and any new optimization initiatives recommended for the flight. The disclosed system also accesses the current state of the flight, including key parameters such as speed, altitude, fuel, and performance data, for example.

A deviation in any of the above parameters is evaluated to assess the impact to the optimum plan. When the deviation affects the mission parameters (such as schedule adherence, for example) a re-plan (without changing the route) is initiated. Also, for deviations initiated by the operator, such as a lateral shortcut or change in flight level, for example, the disclosed system evaluates the deviations against the mission parameters, and makes necessary updates to the rest of the mission in accordance with the initiated change.

For example, when evaluating a flight optimization initiative, such as route direction, for example, from ground, a real time of arrival (RTA) is set at the destination equal to an estimated arrival time to ensure schedule adherence. RTA is a mechanism that maintains a time of arrival at any given waypoint by managing the speed profile en route (subject to regulatory flight plan restrictions). The RTA function re-computes the speed profile to ensure the RTA can be met. If the RTA cannot be adhered to with the proposed optimization initiative, the same is discarded or adjusted until the RTA can be met. This ensures that the optimization initiative provided can be met, and does not disrupt the key mission parameters.

The state of art in optimized flight operation is Cost Index (CI) flying. Cost index flying ensures that the cost of flight operation is apportioned between time cost and fuel cost in such a manner that the total cost remains minimum. Though cost index flying can minimize the impact of change in en route weather or flight level, cost index flying cannot (1) ensure adherence to mission schedule, (2) re-plan and re-optimize the mission due changes in conditions, plan, trajectory, or forecast, or (3) prioritize operating criteria (such as RTA, speed, or CI, for example) depending on mission requirements.

Existing off-board flight optimization products or solutions provide point solutions such as flight level, route, or speed profile, for example, without the consideration of an overall impact to the flight mission. As an example of a point solution, a flight level advisory system may be a point solution to monitor conducive winds along a flight path. Each of the flight levels above and below a current cruise flight level are evaluated for tail winds in cruise, and a recommendation is provided if significant cruise fuel or time savings will occur. However, this point solution, provided without involving the down path impact to the flight with regard to arrival and gate times, can be counterproductive, especially when the aircraft is put on hold at the destination for arriving early. A holistic approach would consider the down path impact to the flight with regard to arrival and gate times. As another example of a point solution, a shortcut advisory may be a point solution to recommend shortcuts along the flight path. The shortcuts reduce the flight distance, thereby reducing the fuel and time. While this point solution merely considers the time and fuel savings, a holistic solution would also consider the weather and traffic situation in the region of the shortcut before recommending the same. The disclosed system evaluates and adjusts the optimization initiatives against their impact to the overall mission with a holistic approach.

The disclosed system provides off-board applications and/or engines that support in-flight decision making with improvements to the overall safety and efficiency of the flight operations. The disclosed system may include a scenario planner that is initiated for route modification, which may be via pilot request or automatically, based on configuration settings. The scenario planner retrieves the current aircraft state, active flight plan, and performance parameters. The scenario planner retrieves the mission parameters (such as scheduled or estimated time of arrival, for example).

The scenario planner identifies the applicable initiatives for the state of the flight, such as position, fuel, weather, or traffic, for example. For a flight level, the scenario planner may identify a best flight level for given wind and traffic conditions. The scenario planner may identify a direct route by identifying potential upcoming direct options. The scenario planner may identify route deviations which identify alternate routes for weather phenomenon ahead. The scenario planner may identify a Notice to Airman (NOTAM) or Pilot Report (PIREP) which identifies NOTAM/PIREP related restrictions such as a Temporary Flight Restriction (TFR) and turbulence and provides alternate route/flight level/speed recommendations.

The scenario planner may present an applicable initiative, the active flight plan and related parameters, as well as the flight parameters (such as scheduled ETA, for example) to the trajectory generator for evaluation. The trajectory generator may insert the flight parameters into the active flight plan and then insert the initiative provided for evaluation. The trajectory generator may provide a summary of an impact of the initiative to the flight and the corresponding real time arrival cost index.

The scenario planner may review the impact summary. If the impact is within the flight parameters, the initiative is sent to the flight management system for clearances and review along with the real time arrival cost index to be followed. If the Impact of the initiative disrupts the flight parameters, the initiative is re-evaluated for the next best option and the process of evaluation of the flight continues until an initiative is identified.

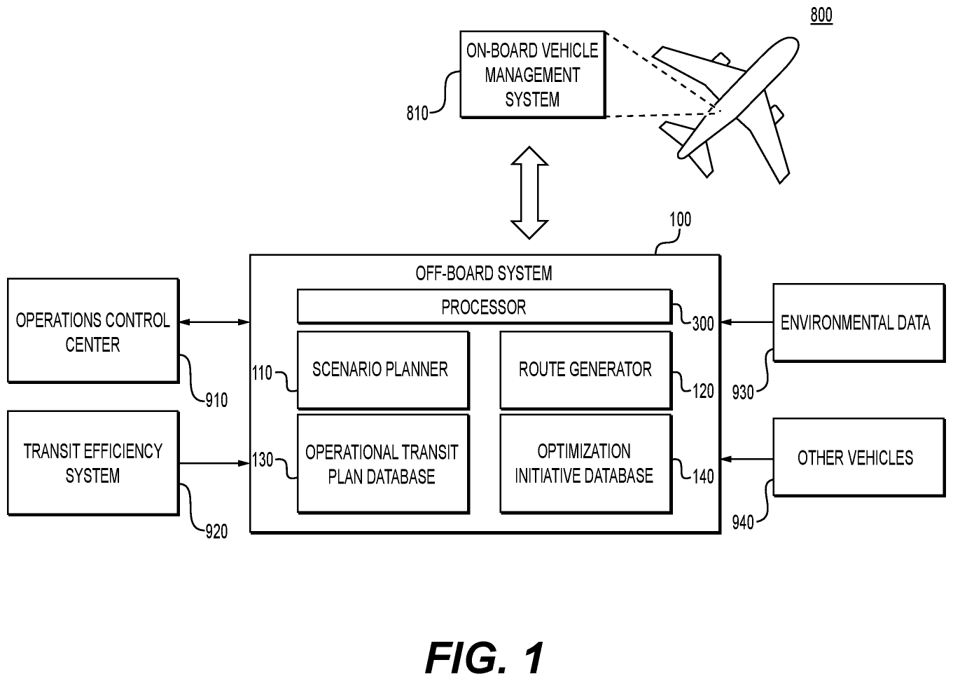

FIG. 1 depicts an exemplary system infrastructure for an off-board system to communicate with a vehicle management system onboard a vehicle and optimize a transit of the vehicle with an estimated time of arrival to a destination during the transit of the vehicle, according to one or more embodiments.

As shown in FIG. 1, an off-board system 100 to communicate with onboard vehicle management system 810 onboard a vehicle 800 and optimize a transit of the vehicle 800 with an estimated time of arrival to a destination during the transit of the vehicle 800 may include processor/controller 300, scenario planner 110, route generator 120, operational transit plan database 130, and optimization initiative database 140.

Off-board system 100 may communicate wirelessly with onboard vehicle management system 810 of vehicle 800, operations control center 910, transit efficiency system 920, environmental data center 930, and other vehicles 940.

Operational transit plan database 130 may store an operational transit plan for the vehicle 800. The operation transit plan may be an operational flight plan for vehicle 800, which may be an aircraft. The flight plan may include a route plan for the aircraft and a speed plan for the aircraft. The route plan may include latitude positions, longitude positions, and altitude positions, for example. The speed plan may include different speeds for different positions along the route. Operational transit plan may also include a planned time of arrival for the aircraft to a destination, and may include runway information, gate information, taxi time from the runway to the gate, and other factors that may influence the arrival time of the aircraft to the gate for passengers to disembark from the aircraft.

Scenario planner 110 may receive data impacting the estimated time of arrival of the vehicle 800 to the destination, and optimize, based on the received data, a parameter for an operation of the vehicle 800 to maintain the estimated time of arrival to the destination within a threshold time. Data impacting the estimated time of arrival of the vehicle 800 may include, but are not limited to, a difference between estimated and actual zero fuel weight, a takeoff delay, destination airport request for early or delayed arrival, ATC permission for airline-initiated en route shortcut, ATC permission for airline-initiated level change, ATC requested en route delay, destination holding, and a change in weather, for example.

Route generator 120 may insert the received data into an evaluation copy of the stored operational transit plan, evaluate a change to the estimated time of arrival based on the inserted data and the optimized parameter, and generate an impact summary based on the evaluated change. Scenario planner 110 may be further configured to send the optimized parameter to the onboard vehicle management system 810 based on the impact summary. Scenario planner 110 may be further configured to choose another parameter for optimization when the impact summary indicates the change to the estimated time of arrival is outside a threshold value.

For example, when evaluating a flight optimization initiative, such as route direction, for example, from ground, a real time of arrival (RTA) is set at the destination equal to an estimated arrival time to ensure schedule adherence. RTA is a mechanism that maintains a time of arrival at any given waypoint by managing the speed profile en route (subject to regulatory flight plan restrictions). The RTA function re-computes the speed profile to ensure the RTA can be met. If the RTA cannot be adhered to with the proposed optimization initiative, the same is discarded or adjusted until the RTA can be met. This ensures that the optimization initiative provided can be met, and does not disrupt the key mission parameters.

Optimization initiative database 140 may store an optimization initiative for the vehicle, and scenario planner 110 may be further configured to optimize the parameter based on the received data and the optimization initiative. The optimization initiative may include a restriction to one or more of a speed or route of vehicle 800. For example, when vehicle 800 is an aircraft, the aircraft may be restricted to a maximum speed below a certain altitude, or to a certain route along a landing pattern.

Vehicle 800 may be an aircraft and the parameter may be one or more of a flight level, a direct route, or a route deviation. However, the disclosure is not limited thereto, and the vehicle may be any type of aircraft, spacecraft, watercraft, or ground-based vehicle.

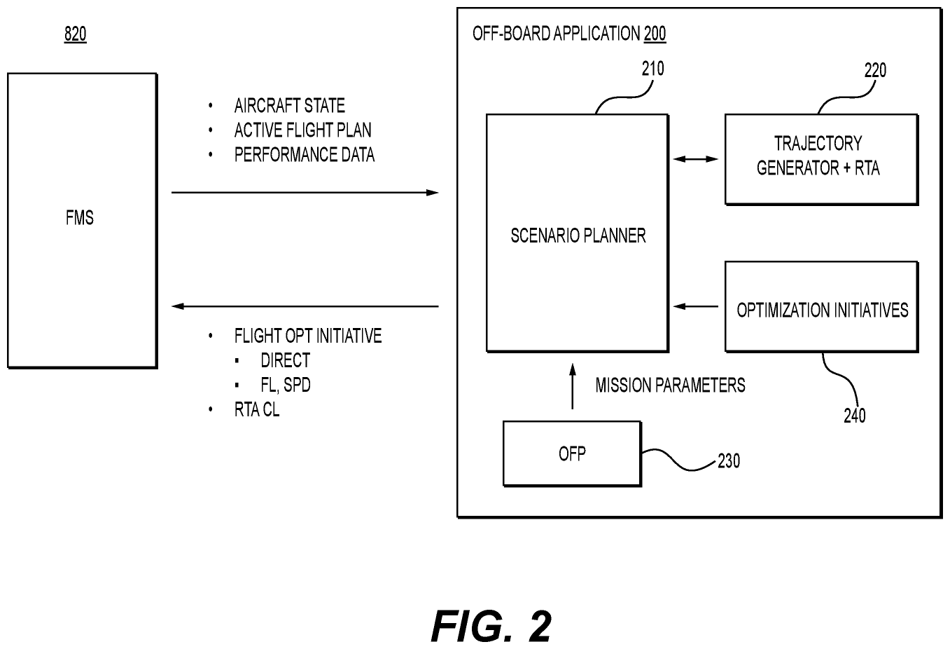

FIG. 2 depicts an exemplary system infrastructure for an off-board system to communicate with a flight management system onboard an aircraft and optimize a flight of the aircraft with an estimated time of arrival to a destination during the flight of the aircraft, according to one or more embodiments.

As shown in FIG. 2, off-board application 200 (similar to off-board system 100) may be used in an example embodiment where vehicle 800 is an aircraft. Off-board application 200 may be in communication with flight management system (FMS) 820 (similar to onboard vehicle management system 810). Off-board application 200 may include scenario planner 210, trajectory and real time arrival generator 220, operational flight plan database 230, and optimization initiative database 240 (similar to scenario planner 110, route generator 120, operational transit plan database 130, and optimization initiative database 140, respectively).

Off-board application 200 may send and receive various data to and from onboard flight management system 820. For example, flight management system 820 may send one or more of a state, active flight plan, or performance data of vehicle 800. For example, off-board application 200 may send one or more of a flight optimization initiative, direct route, fuel or speed plan, or real time arrival cost index to onboard flight management system 820.

The architecture of off-board application 200 is similar to that of off-board system 100, and is not repeated here.

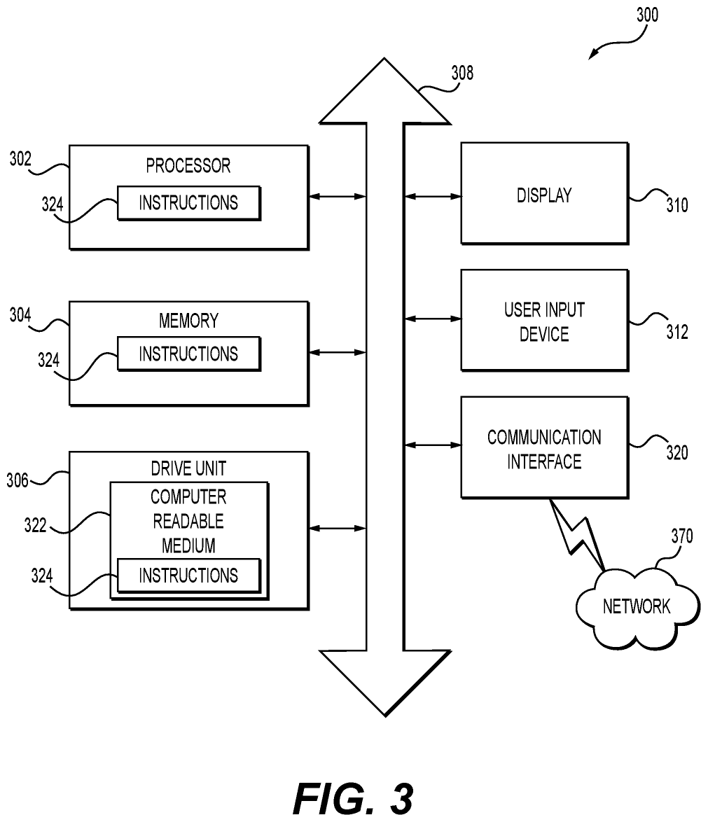

FIG. 3 depicts an implementation of a controller 300 that may execute techniques presented herein, according to one or more embodiments.

The controller 300 may include a set of instructions that can be executed to cause the controller 300 to perform any one or more of the methods or computer based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

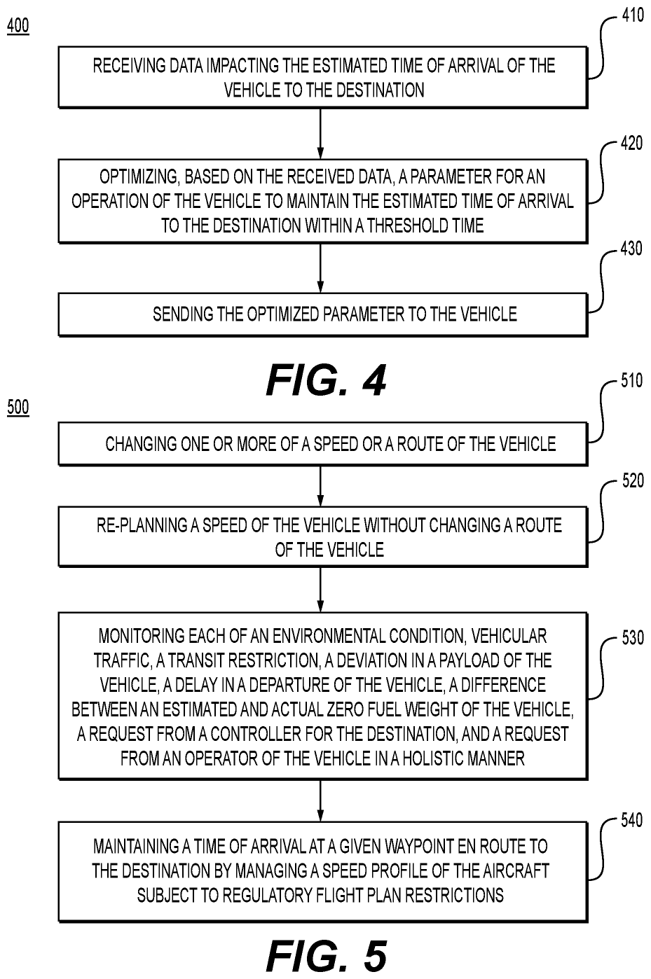

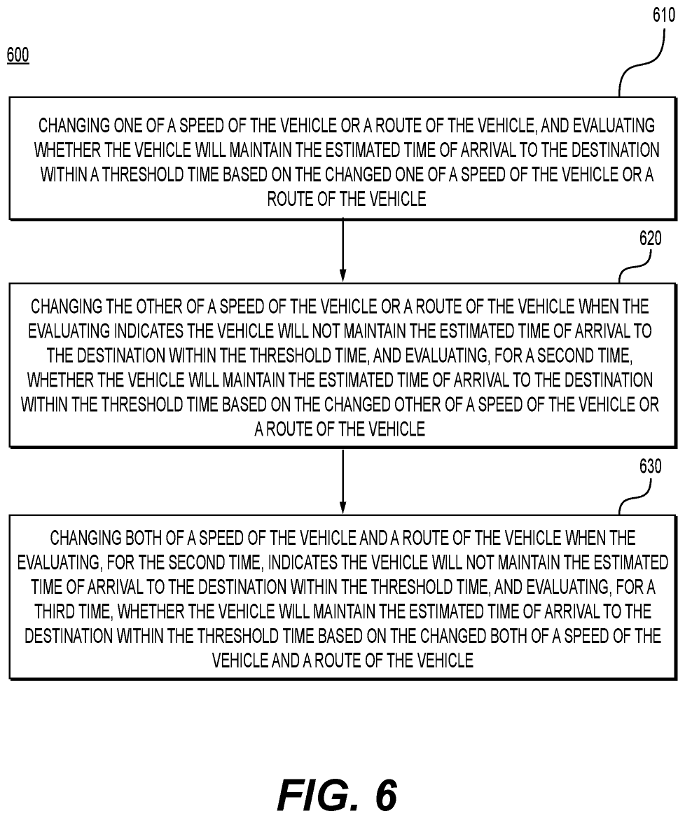

FIGS. 4-6 depict a flowchart of a method for optimizing a transit of a vehicle with an estimated time of arrival to a destination, according to one or more embodiments.

A method 400 may optimize a transit of a vehicle 800 with an estimated time of arrival to a destination. Method 400 may include during the transit of the vehicle 800, performing, by one or more processors or controllers 300 located off-board the vehicle 800, various operations. The various operations may include receiving data impacting the estimated time of arrival of the vehicle 800 to the destination (operation 410), optimizing, based on the received data, a parameter for an operation of the vehicle 800 to maintain the estimated time of arrival to the destination within a threshold time (operation 420); and sending the optimized parameter to the vehicle (operation 430).

As an example, a departure of vehicle 800 may be delayed by fifteen minutes due to a technical fault. Method 400 may monitor the delay in Estimated Departure time and Actual Departure time based on a Position report from ACARS or ADS-B data. The method 400 may identify various options along the flight to handle the delay en route. The identified options may include shortcuts in the route, a change in flight levels, or a change in speed, for example. Based on the optimized parameters, method 400 may optimize the parameters, including one or a combination of the identified options, by balancing the fuel burn versus the time gained. Method 400 may alert the crew of vehicle 800 at the time of the selected optimizing when the option becomes applicable. For example, the shortcut option may be alerted to the crew ten minutes before reaching the start of the shortcut waypoint. Method 400 may provide an improvement over the current technology, which may include mere recommendations of rule-of-thumb mechanisms. The rule-of-thumb mechanisms in this example may be increasing speed alone to offset the delay.

The received data may include one or more of an environmental condition, vehicular traffic, a transit restriction, a deviation in a payload of the vehicle 800, a delay in a departure of the vehicle 800, a difference between an estimated and actual zero fuel weight of the vehicle 800, a request from a controller, such as a controller in operations control center 910, for example, or a request from an operator of the vehicle 800. The vehicular traffic may include information associated with another vehicle using a passenger disembarking point designated for the vehicle. Optimizing the parameter (operation 420) may be further based on one or more of a transit plan for the vehicle 800, current weather, or optimization initiatives recommended for the transit.

For example, when evaluating a flight optimization initiative, such as route direction, for example, from ground, a real time of arrival (RTA) is set at the destination equal to an estimated arrival time to ensure schedule adherence. RTA is a mechanism that maintains a time of arrival at any given waypoint by managing the speed profile en route (subject to regulatory flight plan restrictions). The RTA function re-computes the speed profile to ensure the RTA can be met. If the RTA cannot be adhered to with the proposed optimization initiative, the same is discarded or adjusted until the RTA can be met. This ensures that the optimization initiative provided can be met, and does not disrupt the key mission parameters.

Method 400 may further include various operations illustrated in method 500. For example, optimizing the parameter (operation 420) may include changing one or more of a speed or a route of the vehicle 800 (operation 510). Optimizing the parameter (operation 420) may include re-planning a speed of the vehicle 800 without changing a route of the vehicle 800 (operation 520). Method 500 may include monitoring each of an environmental condition, vehicular traffic, a transit restriction, a deviation in a payload of the vehicle 800, a delay in a departure of the vehicle 800, a difference between an estimated and actual zero fuel weight of the vehicle 800, a request from a controller for the destination, and a request from an operator of the vehicle 800 in a holistic manner (operation 530).

The vehicle 800 may be an aircraft. Optimizing the parameter (operation 420) may be based on one or more of speed, altitude, fuel, or performance data of the aircraft. Optimizing the parameter (operation 420) may include maintaining a time of arrival at a given waypoint en route to the destination by managing a speed profile of the aircraft subject to regulatory flight plan restrictions (operation 540).

Method 400 may further include various operations illustrated in method 600. Optimizing the parameter (operation 420) may include changing one of a speed of the vehicle or a route of the vehicle, and evaluating whether the vehicle will maintain the estimated time of arrival to the destination within a threshold time based on the changed one of a speed of the vehicle or a route of the vehicle (operation 610). Optimizing the parameter (operation 420) may include changing the other of a speed of the vehicle or a route of the vehicle when the evaluating indicates the vehicle will not maintain the estimated time of arrival to the destination within the threshold time, and evaluating, for a second time, whether the vehicle will maintain the estimated time of arrival to the destination within the threshold time based on the changed other of a speed of the vehicle or a route of the vehicle (operation 620). Optimizing the parameter (operation 420) may include changing both of a speed of the vehicle and a route of the vehicle when the evaluating, for the second time, indicates the vehicle will not maintain the estimated time of arrival to the destination within the threshold time, and evaluating, for a third time, whether the vehicle will maintain the estimated time of arrival to the destination within the threshold time based on the changed both of a speed of the vehicle and a route of the vehicle (operation 630).

Optimizing the parameter (operation 420) may include evaluating and adjusting optimization initiatives against an overall impact to transit of the vehicle 800. Receiving data impacting the estimated time of arrival of the vehicle 800 to the destination (operation 410) may be based on one or more of a change in the data, a request from an operator of the vehicle 800, or a periodic update.

The disclosure describes a comprehensive mechanism to manage in-flight deviations by integrating features and functions of a flight management system into flight safety and efficiency advisories. The disclosed system may be hosted in the airline operational control and may perform the following operations in real-time during a flight: (1) continuously monitor the mission and operating conditions against dynamic factors such as weather and traffic, for example, (2) prioritize the operating criteria (such as real time of arrival, speed, or cost index, for example) based on a prevailing mission requirement, and (3) re-plan and advise the mission as per operator configuration.

The disclosed systems and methods may avoid disruptions in flight operations due to in-flight deviations and maintain the time of arrival for every flight, thereby avoiding a cascading effect of early or late arrivals on airline and ATC operations, disruption in ground handling, and inconvenience to passengers.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for optimizing a transit of a vehicle with an estimated time of arrival to a destination, the method comprising:
during the transit of the vehicle, performing, by one or more processors located off-board the vehicle, operations including:
receiving data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle;
optimizing, based on the received data, a parameter for an operation of the vehicle to maintain the estimated time of arrival to the destination within a threshold time, wherein the optimizing the parameter includes changing one or more of a speed or a route of the vehicle; and
sending the optimized parameter to the vehicle.

2. The method of claim 1, wherein the vehicular traffic includes information associated with another vehicle using a passenger disembarking point designated for the vehicle.

3. The method of claim 1, wherein the received data is a difference between an estimated and actual zero fuel weight of the vehicle.

4. The method of claim 1, wherein the optimizing is further based on one or more of a transit plan for the vehicle, current weather, or optimization initiatives recommended for the transit.

5. The method of claim 1, wherein the optimizing includes re-planning a speed of the vehicle without changing a route of the vehicle.

6. The method of claim 1, further comprising:
monitoring each of an environmental condition, vehicular traffic, a transit restriction, a deviation in a payload of the vehicle, a delay in a departure of the vehicle, a difference between an estimated and actual zero fuel weight of the vehicle, a request from a controller for the destination, and a request from an operator of the vehicle in a holistic manner.

7. The method of claim 1, wherein the vehicle is an aircraft.

8. The method of claim 7, wherein the optimizing is further based on one or more of speed, altitude, fuel, or performance data of the aircraft.

9. The method of claim 7, wherein the optimizing includes maintaining a time of arrival at a given waypoint en route to the destination by managing a speed profile of the aircraft subject to regulatory flight plan restrictions.

10. The method of claim 1, wherein the optimizing the parameter further includes changing one of a speed of the vehicle or a route of the vehicle, and evaluating whether the vehicle will maintain the estimated time of arrival to the destination within a threshold time based on the changed one of a speed of the vehicle or a route of the vehicle.

11. The method of claim 10, wherein the optimizing the parameter further includes changing the other of a speed of the vehicle or a route of the vehicle when the evaluating indicates the vehicle will not maintain the estimated time of arrival to the destination within the threshold time, and evaluating, for a second time, whether the vehicle will maintain the estimated time of arrival to the destination within the threshold time based on the changed other of a speed of the vehicle or a route of the vehicle.

12. The method of claim 11, wherein the optimizing the parameter further includes changing both of a speed of the vehicle and a route of the vehicle when the evaluating, for the second time, indicates the vehicle will not maintain the estimated time of arrival to the destination within the threshold time, and evaluating, for a third time, whether the vehicle will maintain the estimated time of arrival to the destination within the threshold time based on the changed both of a speed of the vehicle and a route of the vehicle.

13. The method of claim 1, wherein the optimizing evaluates and adjusts optimization initiatives against an overall impact to transit of the vehicle.

14. The method of claim 1, wherein the receiving the data is based on one or more of a change in the data, a request from an operator of the vehicle, or a periodic update.

15. An off-board system to communicate with a vehicle management system onboard a vehicle and optimize a transit of the vehicle with an estimated time of arrival to a destination during the transit of the vehicle, the off-board system comprising:
an operational transit plan database to store an operational transit plan for the vehicle;
a scenario planner to:
receive data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle, and
optimize, based on the received data, a parameter for an operation of the vehicle to maintain the estimated time of arrival to the destination within a threshold time; and
a route generator to insert the received data into an evaluation copy of the stored operational transit plan, evaluate a change to the estimated time of arrival based on the inserted data and the optimized parameter, and generate an impact summary based on the evaluated change,
wherein the scenario planner is further configured to send the optimized parameter to the vehicle management system based on the impact summary.

16. The system of claim 15, further comprising:
an optimization initiative database to store an optimization initiative for the vehicle,
wherein the scenario planner is further configured to optimize the parameter based on the received data and the optimization initiative.

17. The system of claim 16, wherein the optimization initiative includes a restriction to one or more of a speed or route of the vehicle.

18. The system of claim 15, wherein the scenario planner is further configured to choose another parameter for optimization when the impact summary indicates the change to the estimated time of arrival is outside a threshold value.

19. The system of claim 15, wherein the vehicle is an aircraft and the parameter is one or more of a flight level, a direct route, or a route deviation.

20. A non-transitory computer-readable medium storing instructions, that when executed during a transit of a vehicle by at least one processor located off-board the vehicle, perform a method for optimizing the transit of the vehicle with an estimated time of arrival to a destination, the method comprising:
receiving data impacting the estimated time of arrival of the vehicle to the destination, wherein the received data includes one or more of an environmental condition, vehicular traffic, a transit restriction, a deviation in a payload of the vehicle, a delay in a departure of the vehicle, or a difference between an estimated and actual zero fuel weight of the vehicle, a request from a controller, or a request from an operator of the vehicle;
optimizing, based on the received data, a parameter for an operation of the vehicle to maintain the estimated time of arrival to the destination within a threshold time, wherein the optimizing the parameter includes changing one or more of a speed or a route of the vehicle; and
sending the optimized parameter to the vehicle.
